(19) United States
(12) Patent Application Publication
(10) Pub. No.: US 2003/0147628 A1
(43) Pub. Date: Aug. 7, 2003

(54) Apparatus and method for recording digital audio data file

(76) Inventors: Yoon-Deuk Seo, Seoul (KR); Bum-Ho Seo, Seoul (KR); Bong-Ja Choi, Kyoung-gi (KR); Sung-Youl Kim, Seoul (KR); Chang-Sun Oh, Seoul (KR); In-Ha Lee, Kyoungki-Do (KR); Sang-Ho Kwon, Seoul (KR)

Correspondence Address: George C Beck, Foley & Lardner, Washington Harbour Suite 500, 3000 K Street NW, Washington, DC, 20007-5143, US

(21) Appl. No.: 09/959,320

(22) PCT Filed: Dec. 8, 2000
(86) PCT No.: PCT/KR00/01430

(30) Foreign Application Priority Data
Feb. 23, 2000 (WO) PCT/KR00/00144

(51) Int. Cl. H04N 5/783

(52) U.S. Cl. 386/69; 386/95; 386/96

(57) ABSTRACT

The present invention relates to a system for recording and playing digital audio data recorded on a recording media, and, more particularly, a system for recording and playing digital audio data, which can search the digital audio data with high speed. A method for recording digital audio data file comprising a file name field, a data field, and an additional information tag field, on a recording media is provided. The method comprises the steps of recording the file name field on a directory information recording area, recording the data field and additional information tag field on a data recording area, and recording indexing information which is used as a keyword for searching the digital audio data file on the directory information recording area.

### TECHNICAL FIELD

The present invention relates to a digital audio data recording/playing system. In particular, the invention is directed to a digital audio recording/playing system that can search digital audio data that is recorded in recording media, at high speed.

### BACKGROUND ART

Compact disc players have been widely distributed as digital audio playing system. A compact disc can store audio data of about 650 M byte. A compact disc has capacity to store seventy two (72) minutes long digital audio data, if the data has WAV format which has a sample rate of 44.1 KHz. Thus, generally, a compact disc may record digital audio data up to a maximum of twenty (20) music files, assuming that each of the music files has playing time of about four (4) minutes. The display of the conventional compact disc playing system shows serial numbers of the recorded digital audio data. The user can listen to the desired music by choosing the serial number of the audio data that he/she wants to listen to.

In addition to the compact disc system, there has been system for playing digital audio data using MPEG2 Layer 3 format, i.e., MP3 format, compression. MP3 format has compression ratio of one twelfth of the original WAV format digital data, while the quality of the original sound is nearly maintained. If the MP3 format is employed for recording the digital audio data, almost 850 minute-long analog audio data can be recorded in a single compact disc. That is, 200 pieces of music files can be recorded assuming that each of the music files has playing time of 4 minutes.

When the digital audio data recorded by MP3 format is played, the conventional way for selecting a music file among 300 pieces of music files by referring to serial numbers would consume considerable time. Further, the limitation to man's memorizing ability makes it difficult to select the desired music file by simply referring to the serial number if the number of music files is large, e.g. 300.

In order to solve this problem, there may be a method wherein the file name of digital audio data that is recorded by MP3 format is shown in a display and a user selects wanted audio data by referring to the file name. However, in this method, the user should memorize the file name of the audio data that he/she wants to listen to. In addition, it is considered that selecting the wanted audio data from 300 pieces of music, each of which has different file name from one another, does not substantially differ from selecting the wanted audio data by referring to the serial number.

Alternatively, there may be a method of using ID3 Tag, i.e., information tag relating to audio data defined in MP3 format. ID3 Tag is prepared for additional information for the audio data recorded by MP3 format. ID3 Tag is inserted into the file of MP3 format. The portion of the file of MP3 format, where the ID3 Tag is recorded, is referred to “ID3 Tag Recording Area.” FIG. 1 is a schematic diagram showing a typical format of MP3 file. As illustrated in FIG. 1, a typical MP3 file includes Audio Data Recording Area (101) and ID3 Tag Recording Area (103).

In the method of using ID3 Tag, recorded audio data is indicated by referring to ID3 Tag and the user can select the wanted audio data by referring to the indicated ID3 Tag Information. However, in this method, ID3 Tag Recording Area (103) of all of audio data which is recorded in a compact disc should be referred to and should be indicated. Thus, as the number of audio data increases, there would be problem that the required time for accessing ID3 Tag Recording Area of all audio data increases. Further, all digital audio data of MP3 format does not include ID3 Tag Information in their ID3 Tag Recording Area. In this case, the method of using ID3 tag is not applicable for the digital audio data of MP3 format, since ID3 Tag information is not contained.

In order to overcome the problem, the inventor of the present invention filed a patent application relating to a method of indicating data in playing system for digital audio as Korean Patent Application No. 1999-001553 on Jan. 20, 1999. The method uses recording media in which audio data file of MP3 format is hierarchically recorded in directory structure. The display window of the playing system comprises a directory structure window for displaying information relating to directory structure and selected item window for displaying information relating selected directories or files. The directory structure window shows the title of the upper directory of the selected directory, the number of files and the sub directories which are included in the upper directory. The selected item display shows the order of the selected directory and file and playing time. The user can easily select wanted file from the recording media in which audio data is recorded in hierarchical directory structure.

Further, the inventor filed a patent application relating to a method of classifying and playing audio data which is recorded in digital audio recording media as Korean Patent Application No. 1999-6058 on Feb. 24, 1999. The invention of the application is for providing a method for effectively classifying and playing the audio data by databasing the additional information of audio data recorded in digital audio recording media and the recording position of the audio data in the recording media. The method of classifying and playing the audio data comprises a step of databasing the additional information of audio data and the recording position of the audio data in the recording media, thereafter storing the database and a step of searching the wanted data according to the field value of the database stored in previous step, thereafter playing the data.

According to Korean Patent Application No. 1999-6058, it is necessary to record the additional information in the recording media. In a first embodiment, files in which fields that are necessary for making the database of additional information are recorded, are recorded in the recording media itself. In this case, the file relating to the additional information is also recorded while audio data is recorded in the recording media. In playing, the additional information file is read to be used in classifying and playing the audio data.

In a second embodiment for recording the additional information in a recording media, the field that is necessary for making database of the additional information, is inserted to file name or directory name. In playing, the database of the additional information is made from the file name or the directory name so that the database is used in classifying and playing of the audio data.

### DISCLOSURE OF THE INVENTION

The present invention is improvement to said conventional arts. The object of the invention is to provide a method and an apparatus wherein additional information is inserted when digital audio data is recorded in a recording media, the additional information being used in searching and playing the digital audio data, thereby improving the speed of searching and playing.

Another object of the present invention is to provide a method and an apparatus wherein the format of the digital audio data file which is recorded in a recording media is converted to the format including index information to be used in searching the digital audio data file, thereby improving the speed of searching the digital audio data file.

The other object of the present invention is to provide a method for effectively playing audio data by databasing the additional information that is stored in the digital audio recording media and the recording position of the audio data in the recording media.

In order to accomplish the objects, the present invention provides

### BRIEF DESCRIPTION OF THE DRAWINGS

FIG. 1 conceptually shows a typical MP3 file format.

FIG. 2 shows the block diagram of the structure of an apparatus according to the present invention, for reading and playing digital audio data from recording media in which the digital audio data is recorded.

FIG. 3 is a schematic drawing which illustrates the structure of digital audio data file.

FIG. 4 is a schematic drawing which illustrates the state wherein the digital audio data file is recorded in recording media.

FIG. 5 conceptually shows the structure of database which is stored in root directory of compact disc of ISO-9660 format in the playing apparatus of digital audio recording media illustrated in FIG. 2.

FIG. 6 is a schematic drawing which illustrates directory structure wherein field value is inserted to the file name in order to constitute database, according to the another embodiment of the present invention.

FIG. 7 is a flow chart which shows background processing for constituting in memory of playing system.

### BEST MODE FOR CARRYING OUT THE INVENTION

1. Digital Audio Data, Recording Media and Playing Apparatus

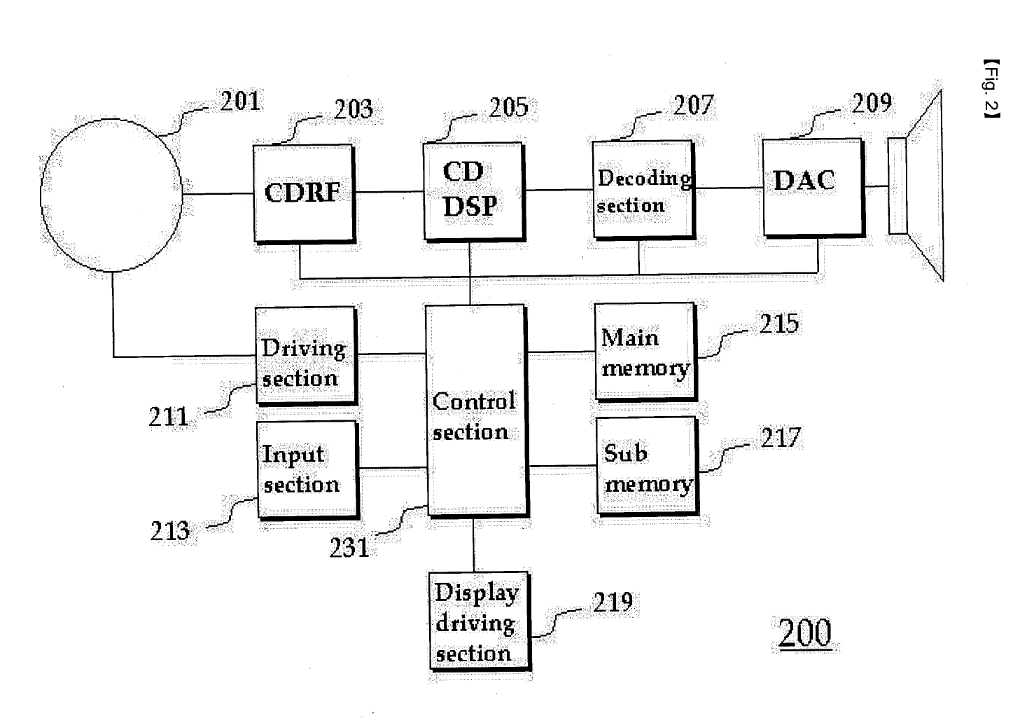

FIG. 2 is a block diagram illustrating the structure of an apparatus for reading and playing digital audio data from recording media in which the digital audio data is recorded, according to the present invention.

Playing apparatus (200) illustrated in FIG. 2 reads and plays the digital audio data while driving the recording media (201). Playing apparatus (200) for digital audio data according to the present invention, comprises reading portion (203) for reading recorded information from recording media (201); digital processing portion (205) for extracting digital information signal from the read recorded information and appropriately processing the signal; decoding portion (207) for generating digital audio signal by decoding digital information signal; digital-analog converting portion (209) for supplying analog signal which is converted from digital audio signal to output apparatus of audio signal; driving portion (211) for moving recording media (201) or reading means, synchronizing with the reading operation of recording media, in order to change the reading position on recording media (201); input portion (213) for receiving input of a command from the user; display portion (219) for showing information of recording media (201), digital audio data or additional information; main memory (215) and sub-memory (217) for recording information which is temporarily generated relating to recording media (201), digital audio data or additional information; and control portion (231) for controlling the portions.

Recording media (201) includes all of the optical or magnetic recording media (201) in which digital data can be recorded, such as CD, MD, DVD, MO. If digital data can be recorded, recording media such as hard disk or diskette is included in recording media (201) that is referred to in the present invention.

In the specification, the unit where audio signal to be consecutively played is recorded, is referred to as an audio data file. That is, when a file is played, the digital audio data recorded in the file is consecutively played unless another instruction occurs. Generally, when music is digitalized, a piece of music is recorded in a file. The digital audio data file may have PCM format wherein audio signal is digitalized without data compression, or MP3 format wherein the audio signal is digitalized with data compression.

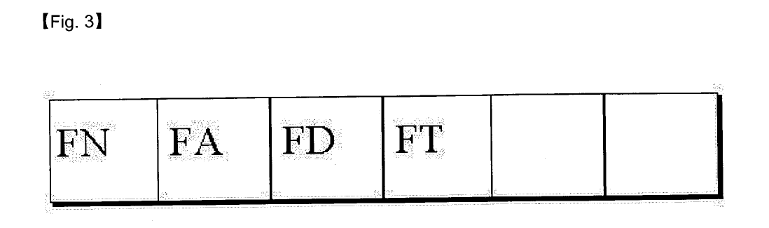

FIG. 3 is a schematic drawing which shows the structure of one digital audio data file. Each of the digital audio data file may be comprised of Field of File Name (FN), Field of File Attribute (FA), Field of Data (FD), Field of Additional Information Tag (FT).

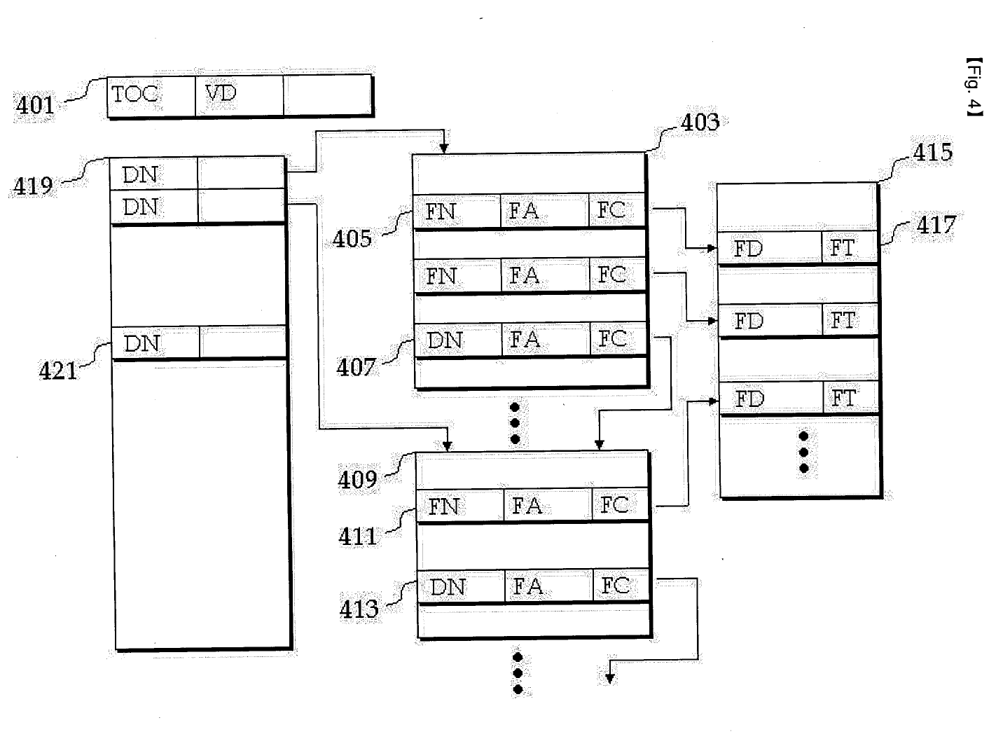

The digital audio data file having the structure of FIG. 3 can be recorded in various recording media. The file is recorded in accordance with the rule of file system that is determined by the characteristic of the recording media. FIG. 4 is a schematic drawing that shows the state wherein a number of digital audio data files are recorded in the recording media according to a predetermined rule of the file system. In FIG. 4, the recording media is a one time recordable-multi readable optical recording media, for example, CD-ROM.

In FIG. 4, recording area (401) for disc information including table of contents (TOC), recording area for root-directory information (403), recording area for sub directory information (409), and recording area for data (415) are assigned in the recording media.

The unique information of the recording media, such as the name of the recording media, total recording capacity and time at which recording is done, are recorded in recording area (401) for disc information. Recording area (401) for disc information may include TOC and Volume Describer (VD). In particular, Volume Describer (VD) has information for indicating the position of directory path information recording area (419) to be described hereinafter.

File information (405) of the highest parent directory, i.e., root directory and information (407) of sub directory are recorded in recording area (403) for root directory information are included in root directory information recording area (403). The recording area (409) for the sub directory information includes file information (411) included in the directory and sub directory information (407) of said directory for the sub directory of the root directory and the sub directory of said sub directory. Further, the file information included in directory information recording area (403, 409) and the data and tags related to the file information are recorded in data recording area (415). The recording media may further include directory path information recording area (419). Path information of all directories that are recorded in the recording media is recorded in directory path information recording area (419). Directory path information recording area (419) can be read by referring to Volume Describer as described in the above.

In directory information recording areas (403, 409), file information (405) that is recorded in the directory and information (407) of sub directory are recorded. File information (405) includes Field of File Name (FN), Field of File Attribute (FA), Field of Data Recording Address (FC). Sub directory information (407) includes Field for Directory Name (DN) and Field for Directory Attribute (DA). File information (405) and sub directory information (407) may have extra field (FE) depending on an employed file system. Data (FD) and Tag Information (FT) that relates to File Information (405) are recorded in the address on data recording area (415), which is indicated by data recording address field (FC) of the file information.

In the above, the present invention is described by referring to the one time recordable-multireadable optical recording media illustrated in FIG. 3. However, multirecordable-multireadable recording media, such as hard disc and floppy disc may employ file system using File Allocation Table (FAT). That is, it is also possible that Data Recording Address Field (FC) does not indicate the address in the direct data recording area, but indicates the address in File Allocation Table (FAT) and that File Allocation Table (FAT) indicates the position in the recording area.

That is, File Name (FN), File Attribute (FA), Data (FD) and Additional Information Tag (FT) constituting the digital audio data file as illustrated in FIG. 3, are recorded in directory information recording area (403, 409) and data recording area (415), as shown in FIG. 4, in accordance with an appropriate file system rule.

In the below, the process of accessing a predetermined digital audio data file will be explained for the case that the digital audio data file is recorded according to the file system shown in FIG. 4. Generally, such a file system is managed by a computer and an operating system that is operated in a computer. Further, the file system can be managed by the playing apparatus for digital audio, which is shown in FIG. 2. Alternatively, an applicative program which is operable in a computer, the operating system, or the playing apparatus for digital audio data, may process the file access to digital audio data. In this specification, the computer, the operating system, the playing apparatus for digital audio data or applicative program that manages the file system which is illustrated in FIG. 4, is referred to as managing system.

First, the access process wherein key word is an inputted file name, will be explained. When a file name is inputted, the managing system compares the inputted file name with File Name Field (FN) in file information (405, 411) in directory information recording areas (403, 409), while searching all sub directory information recording area (409) one by one, starting from root directory information recording area (403). As a result of comparison, if File Name Field (FN) where the same file name as the inputted file name is recorded is found, the wanted Digital Audio Data (FD) on data recording area (415) can be accessed by referring to Data Address Recording Field (FC) corresponding to said File Name Field (FN).

Second, the access process wherein key word is an inputted additional information will be explained. This process is used for a case that the user does not remember the file name of the audio data, but remembers the additional information relating to the audio data, for example, composer or player, or genre. When the additional information is inputted, the managing system extracts Data Address Recording Field (FC) from each file information by referring to all of the file information that is recorded in directory information recording area (403, 409), while searching all of sub directory information recording area (409) one by one, starting from root directory information recording area (403). Then, Additional Information Tag Field (FT) on data recording area (415) which is indicated by Data Address Recording Field (FC), is searched. If Tag Field (FT) in which the same additional information as the inputted additional information is recorded, is found, the wanted Digital Audio Data (FD) can be accessed in data recording area (415) by referring to Data Address Recording Field (FC).

As clearly understood from the above, the access process for digital audio data by referring to file name differs from the access process for digital audio data by referring to additional information. That is, when referring to the file name, it is necessary only to search directory information recording area (403). However, when referring to the additional information, it is necessary to search not only directory information recording area (403) but also data recording area (415). Further, all of additional information tag field (417) should be read out. Thus, it can be seen that the file access time by referring to the additional information is longer than the file access time by referring to the file name.

2. File Format of Digital Audio Data

Digital audio data file is comprised of File Name (FN), File Attribute (FA), Data (FD), and Additional Information Tag (FT). According to the present invention, File Name (FN) and File Attribute (FA) are recorded in directory information recording area (403, 409); Data (FD) and Additional Information Tag (FT) is recorded in data recording area (415); and the additional information which would be used as keywords when the digital audio data is searched is recorded in directory information recording area (403, 409). In this specification, the file format of digital audio data wherein the additional information which would be used as a keyword when the digital audio data recorded in a recording media is searched, is recorded in directory information recording area (403, 409), is defined as “FIF format.” Further, the additional information which would be used as keyword in FIF format, is defined “index information.”

According to a preferred embodiment, particularly, the index information which would be used as keywords when the digital audio data is searched, is recorded in File Name Field (FN) among directory information recording area (403, 409). In this case, the index information of the digital audio data can be expressed by a file name in the operating systems such as DOS and Windows.

According to another embodiment, particularly, the index information which would be used as keywords when the digital audio data is searched, is recorded in a predetermined field except for File Name Field (FN) among directory information recording area (403, 409). That is, the index information which would be used as keywords is recorded in File Attribute Field (FA) or Extra Field (FE). In this case, the index information of the digital audio data is recorded in the form of hidden information that cannot be recognized by the file name, in the operating systems such as DOS or Windows. It seems that the recorded digital audio data file has a conventional file name through a traditional computer, operating system, or playing apparatus for digital audio. However, the use of applicative program according to the present invention makes it possible to indicate the additional information with the file name in addition to the conventional file name.

According to a preferred embodiment, as keywords for searching digital audio data, the additional information such as title, composer or player and genre of the music formatted to the digital audio data file, may be used. In this case, it is desirable that the additional information is distinguished from one another by a predetermined distinguisher. For example, in the embodiment employing FIF format wherein additional information is recorded in File Name Field (FN), the additional information is distinguished by use of the mark “[” and “].” In this case, operating systems such as DOS and Windows can express the file name of the digital audio data file in FIF format as the form of “[player] [title of the music] [genre].extension.” However, the kinds of the index information for searching digital audio data and the arranging order thereof are not limited to the above embodiments. They can have various forms and applications. It should be noted that the spirit of the present invention is not limited to the above embodiments. For example, the file name of a digital audio data file has the form of “[title of music] [singer] [genre]. extension” or “[title of music] [singer] [genre] [miscellaneous additional information] extension.”

3. Inserting Method, Apparatus and Program of Index Information

According to the preferred embodiments of the present invention, a method, apparatus and program for converting a digital audio data file into FIF format, are provided. Digital audio data file is comprised of File Name (FN), File Attribute (FA), Data (FD), and Additional Information Tag (FT). According to the present invention, File Name (FN) and File Attribute (FA) are recorded in directory information recording area (403, 409); Data (FD) and Additional Information Tag (FT) is recorded in data recording area (415); and the additional information which would be used as keyword when the digital audio data is searched is recorded in directory information recording area (403, 409).

According to the preferred embodiment of the present invention, particularly, the additional information which would be used as keywords when the digital audio data is searched, is recorded in File Name Field (FN) among directory information recording area (403, 409). According to another embodiment of the present invention, particularly, the index information which would be used as keywords when the digital audio data is searched, is recorded in a predetermined field except for File Name Field (FN) among directory information recording area (403, 409). That is, the index information which would be used as keywords is recorded in Attribute Field (FA) or Extra Field (FE).

The additional information which would be used as keywords when the digital audio data is searched, can be obtained by direct input of the user or by extracting the additional information from Additional Information Tag (FT).

When the additional information can be obtained by direct input of the user, in the embodiment wherein the additional information regarding the title, composer or player, and genre of the music formatted to the audio data file is used as keywords for searching digital audio data, the title, the composer or player, and genre of the music are directly inputted by the user. Further, when the additional information can be obtained by extracting the additional information from Additional Information Tag (FT), the additional information is obtained by reading the field of the title, composer or player, and genre of the music, of the digital audio data file.

4. Digital Audio Data Format Converting Method, Apparatus and Program

According to the present invention, a method, an apparatus and a program for converting the conventional digital audio data format to the digital audio data format to which index information is inserted according to the present invention.

If File Name (FN), File Attribute (FA), Data (FD) and Additional Information Tag (FT) are recorded in recording media and if File Name (FN) and File Attribute (FA) are recorded in directory information recording area (403, 409), and Recording Data (FD) and Additional Information Tag (FT) are recorded in data recording area (415), the method converts the digital audio data format to the format of the present invention by recording the additional information which would be used as keywords when the digital audio data will be searched in directory information recording area (403, 409).

According to a preferred embodiment of the present invention, the format conversion is performed by recording the additional information which would be used as keywords when digital audio data is searched in directory information recording area (403, 409), in particular, the area in which File Name Field (FN) is recorded. According to the other embodiment of the present invention, the format conversion is performed by recording the additional information which would be used as keywords when digital audio data is searched, in directory information recording area (403, 409), in particular, an area except for the area in which File Name Field (FN) is recorded. That is, the additional information which would be used as keywords is recorded in Attribute Field (FA) or Extra Field (FE).

The method of obtaining the additional information which would be used as keywords when the digital audio data is searched is almost same as the method described in the above. Thus, the details of the method is not mentioned.

5. Method, Apparatus and Program by Which Digital Audio Data Is Recorded in Recording Media

The present invention provides a method, an apparatus and a program by which digital audio data file is recorded in recording media as a format of the present invention.

The method records File Name (FN), File Attribute (FA), Data (FD), and Additional Information Tag (FT) which constitute digital audio data file, in recording media. File Name (FN), File Attribute (FA) are recorded in directory information recording area (403, 409). Data (FD) and Additional Information Tag (FT) are recorded in data recording area (415). The additional information which would be used as keywords when the digital audio data is searched, is recorded in directory information recording area (403, 409).

According to an embodiment of the present invention, a method which records, in the second recording media, the inputted digital audio data file recorded in the first recording media as FIF format of the present invention. In the first recording media, File Name (FN) and File Attribute (FA) which constitute digital audio data file, are recorded in directory information recording area (403, 409). Data (FD) and Additional Information Tag (FT) are recorded in data recording area (415). When these are recorded in the second recording media, File Name (FN) and File Attribute (FA) are recorded in directory information recording area (403, 409). Further, Data (FD) and Additional Information Tag (FT) are recorded in data recording area (415). In addition, the additional information which would be used as keywords when the digital audio data is searched, are recorded in directory information recording area (403, 409). This embodiment is particularly useful when the first recording media and the second recording media have different file system from each other. That is, if the first recording media is a floppy disc and the second recording media is a hard disc, the format of the digital audio data file is converted to FIF format of the present invention when the file recorded in the floppy disc is copied to the hard disc.

6. The Program That Converts the Conventional CD Data to Compressive Digital Audio Data Automatically

According to the present invention, a method, a apparatus and a program that convert digital audio data which is recorded in CD as CD audio format into FIF format of the present invention.

The present method reads the digital audio data file which is recorded in a CD as CD audio format; extracts the digital audio data; generates object data (FD) by encoding the data by a demanded format; generates File Name, File Attribute (FA) and Additional Information Tag (FT); and records File Name (FN), File Attribute (FA), Data (FD) and Additional Information Tag (FT) on recording media. File Name (FN) and File Attribute (FA) are recorded in data recording area (403, 409); Data (FD) and Additional Information Tag (FT) are recorded in data recording area (415); and the additional information which would be used when the digital audio data is searched is generated to be recorded in directory information recording area (403, 409).

According to an embodiment of the present invention, it is preferred that the digital audio data which is recorded in a CD by CD audio format is compressed by a compression algorithm before being recorded in recording media. For example, the digital audio data recorded in a CD by CD audio format can be compressed to a file which is modulated by PCM format, a file of WAV format or MP3 compression algorithm, thereafter being recorded in the recording media. In this case, compression algorithm may be for example, MP3 compression algorithm.

The additional information which would be used as keywords when the digital audio data is searched, may be obtained by a user's direct input or extracting the information after accessing to CD information database.

In the former case, if title of the music, composer or player, and genre of the music are used as the keywords for search of digital audio data, the additional information of the title of the music, composer or player, and genre of the music are directly inputted by the user. In the latter case, title of music, composer or player, and genre of music of digital audio data file is obtained with the unique information of the audio CD as keywords by accessing CD information database.

The CD information database means the database in which various additional information regarding the audio CD is recorded by means of unique information of the audio CD. Generally, such a database can be accessed through a communication network such as internet. Further, in the CD information database, information such as title of music, composer and player, and genre of music regarding a number of music is recorded. If the user who wishes to obtain detailed information regarding an audio CD accesses the CD information database through a communication network and sends the unique information of the audio CD to the CD information database, the CD information database searches the audio data conforming to the sent unique information and sends the additional information regarding the audio data to the user.

In the file system shown in FIG. 4, the unique information such as the title, total recording capacity, time at which the audio CD is made may be used as unique information for distinguishing a number of audio CDs from one another in the CD information database.

7. Method for Classifying and Playing Audio Data Recorded in Digital Audio Recording Media

In the below, audio data means digitalized audio signal and additional information means information for classification and play of audio data, such as singer, genre, year of making, album, title of music, classification mark. Further, position information means the position information for accessing the audio data on the recording media. In addition, database means the database having additional information and position information for playing audio data by classification as field.

The first embodiment of the present invention is a mode wherein database is made in recording media itself. For example, when music is recorded in a CD, the database is also recorded in the CD as files so that playing system reads the files to recognize all information necessary for playing the CD by classification, thereby facing the user's request of playing by classification.

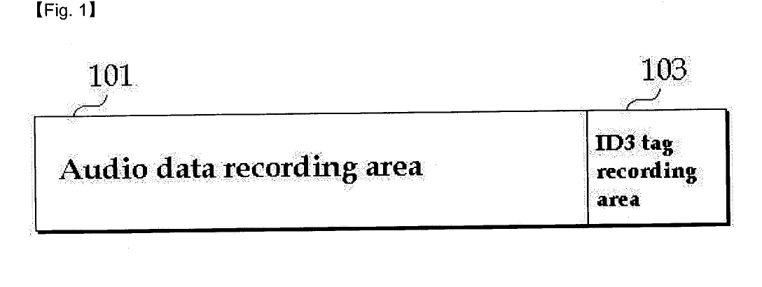

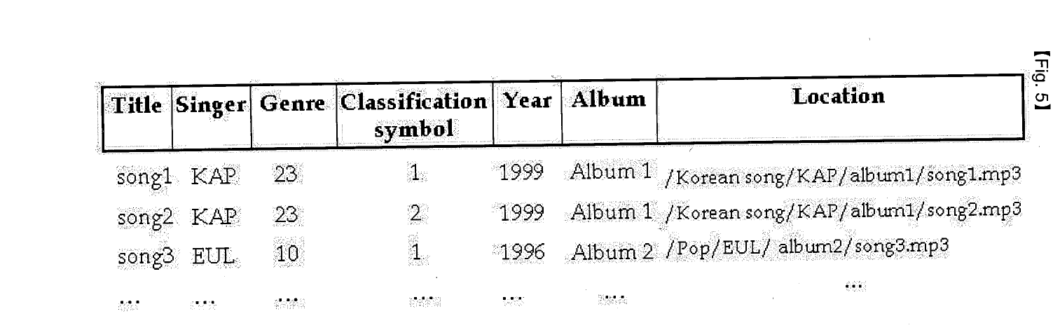

FIG. 5 shows an example of the contents of a database that is recorded in ISO-9660 format CD in a playing system of digital audio recording media illustrated in FIG. 1.

As shown in FIG. 5, the database recorded in CD can store title of music, singer, genre, classification number, year of making, album and the position information of the music on CD.

If such a database is disposed in the root directory of CD, the access is rapid. Further, only first one reading make it possible to have databased information for playing by classification. Thus, this system can show immediate response to the user's request since the database is classified without access time to ID 3 Tag of files for playing by classification and since the music can be immediately found by use of position information stored in the database.

For example, if a user wishes to play audio data by classification of singer, the playing system shows the signer list from the database. If the user wishes to play music of singer “A,” the playing system shows the list of music of singer “A” from the database. The database shown in FIG. 5 shows music 1 and music 2. If the user selects music 1, it is possible that the position of music 1 is accessed by using the position information of music 1 from the database. Thus, it is possible that the required time for finding music by analyzing path table, directory information and each audio data, is reduced.

In another embodiment of method of classifying and playing audio data stored in a digital audio recording media, according to the present invention, database is made only by file name or directory name by putting necessary field for making database to the file name or directory name. In the playing system, database is made in memory by use of record information and file position information which are included in file name or directory name by use of position information of each file included in directory recording. Necessary additional information for playing by classification is inserted to the file name or directory name when manufacturing CD. Using this file name or directory name, database is made in memory of playing system. The audio data is classified and played by the database. This system can fill the field information of the database only by searching the path table and directory information without access time to ID 3 Tag of music. Thus, it is possible to make rapid database. Further, since the made database has position information of music and additional information that is necessary for playing by classification, only one time random access makes it possible to play music after completion of classification.

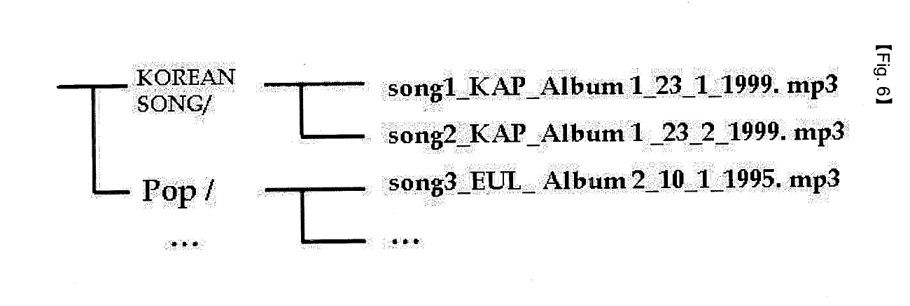

FIG. 6 shows an example of directory structure wherein the field value of database is inserted to file name according to another embodiment.

The example shown in FIG. 6 is a directory structure which is made using long file name by extension of ISO-9660 file system. Music under each directory indicates additional information such as title of music, singer, album name, genre, classification number and year of making.

The playing system recognizes and reads the position of path table by reading PVD of CD to recognize the directory structure of CD. Further, the system can read the file name in directory by reading each directory recording. At that time, database is structured in memory by field value information of the database included in the file name and the position information of the file in directory recording. By use of the database, the files are played by classification according to the user's request.

In this way, since the playing system has the database for playing by classification only with ISO-9660 path table and directory information, it is possible to save time for obtaining additional information regarding all of audio data by accessing and comparing directly to each audio data.

Background processing makes it also possible to make the database in memory of playing system.

When CD is inserted to a playing system for the first time, the playing system recognizes directory structure using PVD and path table, thereafter performing reading and classifying files while entering user input waiting mode. The data transmission rate that is necessary for playing the file the user selects is 16 Kbyte/sec for a file which is encoded by 128 Kbps. Thus, if the data transfer rate of playing apparatus is about 150 Kbyte/sec (1×Max), the database can be made by use of time during which the remaining 134 Kbyte/sec can be transferred. By the same way, if the data transfer rate of the playing system is 2×Max, the database can be made by use of the time during which 284 Kbyte/sec can be transferred. This is referred to as “background processing.”

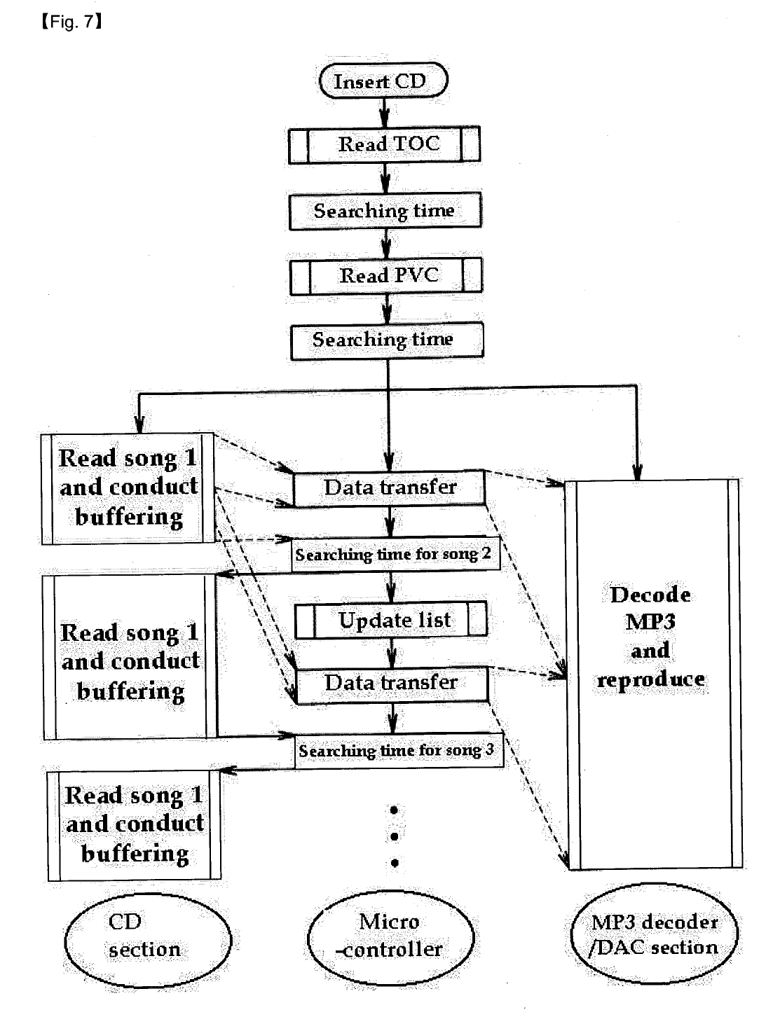

FIG. 7 shows the background processing for making database in memory of a playing system.

In FIG. 7, CD, micro-controller and MP3 decoder simultaneously operates. The CD reads music 1 and buffers it. The micro-controller sends the buffered data, thereafter searching music 2 and reading ID3 Tag to classify it. Then, the controller reads music 1 again and buffers it. These operations are continuously performed while music 3 is read and is classified. Thus, it is possible that the audio data is played by additional information when the audio data is played by classification after whole databases are made.

As described in the above, according to the present invention, searching by field constituting database since the database regarding additional information of audio data recorded in digital audio recording media and regarding position information of audio data. Further, there is advantage that a user can rapidly find a wanted music and play the music due to the position information.

Further, if the database that is necessary for providing playing function by classification is recorded in directory name or file name when the database is obtained from CD-ROM (or digital recording media), the playing system can obtain all of the necessary information for the database only by reading directory recording. Thus, the present invention can save the time for searching each file, compared to the conventional way. Therefore, the playing system according to the present invention quickly responses to the user's request of displaying by classification and playing.

### INDUSTRIAL APPLICABILITY

According to the present invention, since the index information is inserted when digital audio data is recorded in a recording media and since the index information can be used when the digital audio data is searched and played, the search and play can be accelerated.

According to the present invention, when the user wishes to search the digital audio data by use of keyword of additional information of the digital audio data, playing apparatus (200) only has to read directory information reading area (403, 409) of the recording media. There is no need to access to even data recording area (415). Thus, the searching time for digital audio data can be considerably reduced.

Further, the present invention provides method, apparatus, and program that convert digital audio data that is recorded in CD by conventional CD audio format to FIF format in accordance with the present invention. In the recording media which is converted to FIF format by the present invention, it is possible to search audio data by keywords of the additional information, but this is impossible for the conventional CD audio format. In addition, data search by keywords of the additional information can be rapidly performed.

1. Method for recording digital audio data file including file name field, data field and additional information tag field in recording media,
said method comprising step for recording said file name field in directory information recording area on said recording media; step for recording said data field and said additional information tag field in data recording area on said recording media; step for recording index information which is used as keyword when said digital audio data file is searched in said directory information recording area.

2. Method for recording digital audio data file recorded in data recording area on first recording media in second recording media,
said first recording media including file name field included in said digital audio data file which is recorded in directory information recording area on said first recording area, and data field and additional information tag field which are recorded in data recording area on said first recording media,
said method comprising step for recording said file name field in directory information recording area on said second recording area; step for recording said data field and said additional information tag field in data recording area on said second recording media; and step for recording index information which is used as keyword when said digital audio data file is searched in said directory information recording area of said second recording area.

3. Method for recording digital audio data recorded in CD as CD audio format in recording media,
said method comprising step for reading digital audio data recorded in said CD and extracting said read data; step for generating file name and additional information tag; step for recording said file name in directory information recording area on said recording media; step for recording said digital audio data and said additional information tag in data recording area on said recording media; and step for recording index information which is used as keyword when said digital audio data recorded in said recording media is searched in said directory information recording area on said recording media.

4. The method according to one of claims 1 to 3, wherein said step for recording index information is step for recording said index information in the area where said file name field on said directory information recording area is recorded.

5. The method according to one of claims 1 to 3, wherein said digital audio data file digitalizes music and said index information is selected from the group consisting of title of music of said digital audio data file, composer, player, and genre of the music.

6. The method according to one of claims 1 to 3, further comprising step for receiving input of said index information before said step for recording index information.

7. The method according to one of claims 1 to 3, further comprising step for extracting said index information from said additional information tag field before said step for recording said index information.

8. The method according to claim 3, further comprising step for compressing said digital audio data with a predetermined compression algorithm before said step for recording said digital audio data and said additional information tag in said data recording area.

9. The method according to claim 3, further comprising step for accessing CD information database through network; step for extracting unique information of said CD and sending it to said CD information database; and step for receiving said index information from said CD information database, before said step for recording index information.

10. Apparatus for recording digital audio data file including file name field, data field and additional information tag field in recording media,
said apparatus comprising means for recording said file name field in directory information recording area on said recording media; means for recording said data field and said additional information tag field in data recording area on said recording media; means for recording index information which is used as keyword when said digital audio data file is searched in said directory information recording area.

11. Apparatus for recording digital audio data file recorded in data recording area on first recording media in second recording media,
said first recording media including file name field included in said digital audio data file which is recorded in directory information recording area on said first recording area, and data field and additional information tag field which are recorded in data recording area on said first recording media,
said apparatus comprising means for recording said file name field in directory information recording area on said second recording area; means for recording said data field and said additional information tag field in data recording area on said second recording media; and means for recording index information which is used as keyword when said digital audio data file is searched in said directory information recording area of said second recording area.

12. Apparatus for recording digital audio data recorded in CD as CD audio format in recording media,
said apparatus comprising means for reading digital audio data recorded in said CD and extracting said read data; means for generating file name and additional information tag; means for recording said file name in directory information recording area on said recording media; means for recording said digital audio data and said additional information tag in data recording area on said recording media; and means for recording index information which is used as keyword when said digital audio data recorded in said recording media is searched in said directory information recording area on said recording media.

13. The apparatus according to one of claims 10 to 12, wherein said means for recording index information is means for recording said index information in the area where said file name field on said directory information recording area is recorded.

14. The apparatus according to one of claims 10 to 12, wherein said digital audio data file digitalizes music and said index information is selected from the group consisting of title of music of said digital audio data file, composer, player, and genre of the music.

15. The apparatus according to one of claims 10 to 12, wherein said means for recording index information further includes means for receiving input of said index information before recording index information.

16. The apparatus according to one of claims 10 to 12, wherein said means for recording index information further includes means for extracting said index information from said additional information tag field before recording said index information.

17. The apparatus according to claim 12, further comprising means for compressing said digital audio data with a predetermined compression algorithm before recording said digital audio data and said additional information tag in said data recording area.

18. The apparatus according to claim 12, further comprising means for accessing CD information database through network; means for extracting unique information of said CD and sending it to said CD information database; and means for receiving said index information from said CD information database, before recording index information.

19. Computer-executable program for recording digital audio data file including file name field, data field and additional information tag field in recording media,
wherein said program makes computer execute processes comprising step for recording said file name field in directory information recording area on said recording media; step for recording said data field and said additional information tag field in data recording area on said recording media; step for recording index information which is used as keyword when said digital audio data file is searched in said directory information recording area.

20. Computer-executable program for recording digital audio data file recorded in data recording area on first recording media in second recording media,
said first recording media including file name field included in said digital audio data file which is recorded in directory information recording area on said first recording area, and data field and additional information tag field which are recorded in data recording area on said first recording media,
wherein said program makes computer execute processes comprising step for recording said file name field in directory information recording area on said second recording area; step for recording said data field and said additional information tag field in data recording area on said second recording media; and step for recording index information which is used as keyword when said digital audio data file is searched in said directory information recording area of said second recording area.

21. Computer-executable program for recording digital audio data recorded in CD as CD audio format in recording media,
wherein said program makes computer execute processes comprising step for reading digital audio data recorded in said CD and extracting said read data; step for generating file name and additional information tag; step for recording said file name in directory information recording area on said recording media; step for recording said digital audio data and said additional information tag in data recording area on said recording media; and step for recording index information which is used as keyword when said digital audio data recorded in said recording media is searched in said directory information recording area on said recording media.
